(19) United States
(12) Patent Application Publication
(10) Pub. No.: US 2012/0064275 A1
(43) Pub. Date: Mar. 15, 2012

(54) OPTICAL PRESSURE-SENSITIVE ADHESIVE SHEET

(75) Inventors: Hiroaki FUMOTO, Osaka (JP); Hiroaki KISHIOKA, Osaka (JP)

(73) Assignee: NITTO DENKO CORPORATION, Osaka (JP)

(21) Appl. No.: 13/231,377

(22) Filed: Sep. 13, 2011

(30) Foreign Application Priority Data
Sep. 14, 2010 (JP) 2010-205508

(51) Int. Cl. C09J 7/02; B32B 7/06; B32B 27/30

(52) U.S. Cl. 428/41.5; 428/41.8; 428/40.1

(57) ABSTRACT

The present invention provides an optical pressure-sensitive adhesive sheet having excellent punching processability. The optical pressure-sensitive adhesive sheet includes: a pressure-sensitive adhesive body; and a separator on at least one side of the pressure-sensitive adhesive body, where the separator has a Young's modulus of 2 GPa or more in a machine direction and a transverse direction, a breaking strength of 400 MPa or less in a machine direction and a transverse direction, and a thickness of 70 μm or more and 250 μm or less, and a release force of the separator to the pressure-sensitive adhesive body in a 180° peel test at a tensile speed of 30 m/min is 0.8 N/50 mm or more.

### BACKGROUND OF THE INVENTION

1. Technical Field

The present invention relates to an optical pressure-sensitive adhesive sheet used for laminating optical members, or manufacturing optical products.

2. Background Art

Recently, in various fields, display devices such as liquid crystal displays (LCDs) or an input device used by combining with the display device, such as a touch panel, have been widely used. In manufacturing the display device or the input device, a transparent pressure-sensitive adhesive sheet (pressure-sensitive adhesive tape) is used for laminating optical members. For example, the transparent pressure-sensitive adhesive sheet is used to laminate the touch panel and various display devices or optical members such as a protective plate (for example, see Patent Documents 1 to 3). In some cases, the pressure-sensitive adhesive sheet is used after being punch-processed in a desired shape depending on its use or a use state thereof.
Patent Document 1: JP 2003-238915 A
Patent Document 2: JP 2003-342542 A
Patent Document 3: JP 2004-231723 A

### SUMMARY OF THE INVENTION

However, in the punch-processed pressure-sensitive adhesive sheet as described above, there has been a problem with a defect in punching processability such that, when a separator (release liner) is released, a part of the pressure-sensitive adhesive layer is stretched in a thread shape between the separator and the pressure-sensitive adhesive layer (the phenomenon is referred to as a “adhesive stretch”) or a part of the pressure-sensitive adhesive layer is omitted (the phenomenon referred to as a “adhesive omission”). In particular, in the pressure-sensitive adhesive sheet used as an optical use, since step absorbability is required, a relatively soft pressure-sensitive adhesive layer is used in many cases, and in this case, the punching processability tends to be further deteriorated.

The present invention has been made in an effort to provide an optical pressure-sensitive adhesive sheet having excellent punching processability.

The present inventors have intensively studied in order to solve the problems. As a result, the inventors have found that, in the pressure-sensitive adhesive sheet including the separator on at least one side of the pressure-sensitive adhesive body, an optical pressure-sensitive adhesive sheet having excellent punching processability can be obtained by controlling a Young's modulus, breaking strength and thickness of the separator in a predetermined range and controlling a high-speed release force of the separator to the pressure-sensitive adhesive body in a predetermined range, thereby completing the present invention.

That is, the present invention provides an optical pressure-sensitive adhesive sheet including; a pressure-sensitive adhesive sheet; and a separator on at least one side of the pressure-sensitive adhesive sheet, wherein the separator has a Young's modulus of 2 GPa or more in a machine direction and a transverse direction, a breaking strength of 400 MPa or less in a machine direction and a transverse direction, and a thickness of 70 μm or more and 250 μm or less, and a release force of the separator to the pressure-sensitive adhesive body in a 180° peel test at a tensile speed of 30 m/min is 0.8 N/50 mm or more.

In the optical pressure-sensitive adhesive sheet, the pressure-sensitive adhesive body preferably includes an acrylic pressure-sensitive adhesive layer having a storage elastic modulus of 1.0×10⁴ to 1.0×10¹⁴ Pa at −30° C.

In the separator of the optical pressure-sensitive adhesive sheet, a separator preferably includes a separator substrate and a release layer formed on at least one surface of the separator substrate.

In the optical pressure-sensitive adhesive sheet, the release layer is preferably formed of a release treating agent.

In the optical pressure-sensitive adhesive sheet, a thickness of the pressure-sensitive adhesive body is preferably 6 to 250 μm, a total light transmittance of the pressure-sensitive adhesive body in a visible wavelength region is preferably 80% or more, and a haze of the pressure-sensitive adhesive body is preferably 3% or less.

According to the optical pressure-sensitive adhesive sheet of the present invention, since the optical pressure-sensitive adhesive sheet has the above configuration, when the separator is released from the pressure-sensitive adhesive sheet after punch-processing, any defects such as the adhesive stretch and the adhesive omission are not caused, and thus, the optical pressure-sensitive adhesive sheet is excellent in punching processability. In particular, even if the optical pressure-sensitive adhesive sheet has a relatively soft pressure-sensitive adhesive layer, excellent punching processability can be exhibited, and in this case, excellent step absorbability can be exhibited. Even if the optical pressure-sensitive adhesive sheet has a relatively small high-speed release force of the separator, excellent punching processability can be exhibited, and in this case, release workability of the separator after punch-processing is excellent.

### DETAILED DESCRIPTION OF THE INVENTION

Hereinafter, exemplary embodiments of the present invention will be described in detail. In this regard, each of the terms “a” and “at least” used in this specification means “one or more” unless otherwise provided.

An optical pressure-sensitive adhesive sheet according to the present invention (hereinafter, simply, referred to as “pressure-sensitive adhesive sheet of the present invention” in some cases) includes a separator (hereinafter, referred to as “separator of the present invention” in some cases), which has a Young's modulus of 2 GPa or more in a machine direction and a transverse direction, a breaking strength of 400 MPa or less in a machine direction and a transverse direction, and a thickness of 70 μm or more and 250 μm or less, on at least one side of a pressure-sensitive adhesive body, in which a release force of the separator to the pressure-sensitive adhesive body in a 180° peel test at a tensile speed of 30 m/min (referred to as “high speed release force” in some cases) is 0.8 N/50 mm or more. In this specification, the “pressure-sensitive adhesive sheet” generally includes a separator (release liner) and “the remaining part in which the separator is released from the pressure-sensitive adhesive sheet” may be called a “pressure-sensitive adhesive body”. A surface of the pressure-sensitive adhesive layer of the pressure-sensitive adhesive body may be called a “pressure-sensitive adhesive surface”. The pressure-sensitive adhesive sheet in the present invention also includes a tape-shaped sheet, that is, a “pressure-sensitive adhesive tape”.

In the present invention, a machine direction (MD) is a manufacturing line direction (flow direction) in the manufacturing process of the pressure-sensitive adhesive sheet, and in the case of a long tape, the machine direction means a longitudinal direction of the tape. A transverse direction (TD) means a vertical direction (orthogonal direction) to the machine direction.

The pressure-sensitive adhesive sheet of the present invention may be a double-sided pressure-sensitive adhesive sheet in which the separator of the present invention is provided on at least one side of a pressure-sensitive adhesive body (double-sided pressure-sensitive adhesive body) with pressure-sensitive adhesive surfaces on both sides thereof and may be a single-sided pressure-sensitive adhesive sheet in which the separator of the present invention is provided on a pressure-sensitive adhesive body (single-sided pressure-sensitive adhesive body) with a pressure-sensitive adhesive surface at only one side thereof. In the case where the pressure-sensitive adhesive sheet of the present invention is the double-sided pressure-sensitive adhesive sheet, the separator of the present invention may be provided on at least one pressure-sensitive adhesive surface of the pressure-sensitive adhesive body and the separator may not be provided on the other side pressure-sensitive adhesive surface. In the case where the separator is provided on the other pressure-sensitive adhesive surface of the pressure-sensitive adhesive body, the separator may be the separator of the present invention or any separator other than the separator of the present invention (hereinafter, referred to as “other separator” in some cases).

(Separator of the Present Invention)

The separator of the present invention has a Young's modulus of 2 GPa or more in a machine direction and a transverse direction (Young's modulus in a machine direction and Young's modulus in a transverse direction), a breaking strength of 400 MPa or less in a machine direction and a transverse direction (breaking strength in a machine direction and breaking strength in a transverse direction), and a thickness of 70 μm or more and 250 μm or less.

The Young's modulus in a machine direction of the separator of the present invention is 2 GPa or more (for example, 2 to 10 GPa), preferably 2 to 8 GPa, and more preferably 2 to 5 GPa. The Young's modulus in a transverse direction of the separator of the present invention is 2 GPa or more (for example, 2 to 10 GPa), preferably 2 to 8 GPa, and more preferably 2 to 5 GPa. When at least one of the Young's modulus in a machine direction and the Young's modulus in a transverse direction is less than 2 GPa, elasticity of the separator is weak, and thus, punching processability is deteriorated or release workability is deteriorated. The Young's modulus can be measured by a tensile test in accordance with JIS K7113. In detail, for example, the Young's modulus can be measured by pulling a separator cut in a size of width 25 mm×length 115 mm in a machine direction at a speed of 100 mm/min in a gauge line interval (initial length) of 25 mm by using a tensile tester under an atmosphere of 23° C. and 50% RH.

The breaking strength in a machine direction of the separator of the present invention is 400 MPa or less (for example, 50 to 400 MPa), preferably 100 to 350 MPa, and more preferably 200 to 350 MPa. The breaking strength in a transverse direction of the separator of the present invention is 400 MPa or less (for example, 50 to 400 MPa), preferably 100 to 350 MPa, and more preferably 200 to 350 MPa. When at least one of the breaking strength in a machine direction and the breaking strength in a transverse direction is more than 400 MPa, insertion of a blade into the separator is deteriorated, and thus, punching processability is deteriorated. When at least one of the breaking strength in a machine direction and the breaking strength in a transverse direction is less than 50 MPa, in the case where the blade is inserted into the separator, the separator may be bent too much, and thus, punching processability may be deteriorated. The breaking strength can be measured in accordance with JIS Z0237. In detail, when the separator cut in a size of width 25 mm×length 115 mm is pulled in a machine direction at a speed of 100 mm/min in a gauge line interval of 25 mm by using a tensile tester under an atmosphere of 23° C. and 50% RH and the separator is broken, the breaking strength can be measured by measuring a load (tension strength) at which the separator is broken.

A thickness of the separator of the present invention is 70 μm or more and 250 μm or less, preferably 70 μm or more and 200 μm or less, and more preferably 70 μm or more and 150 μm or less. If the thickness is more than 250 μm, it is difficult to insert the blade into the separator. If the thickness is less than 70 μm, elasticity of the separator is weak and lift-off of the separator easily occurs in the punching process, and thus, punching processability is deteriorated.

In the separator of the present invention, the elasticity is reinforced because the Young's modulus in the machine direction and the transverse direction, the breaking strength in the machine direction and the transverse direction, and the thickness are controlled within the above ranges. On this account, lift-off of the separator as described below is hardly occurred in the punching process of the pressure-sensitive adhesive sheet of the present invention. In addition, the pressure-sensitive adhesive sheet is easily bent in the punching process and the pressure-sensitive adhesive layer tends to be pressed into the inside thereof, thus, the pressure-sensitive adhesive layer is hardly protruded from a cutting plane of the pressure-sensitive adhesive sheet after the punching process. As a result, defects such as the adhesive stretch and the adhesive omission are prevented when the separator is released, and thus, excellent punching processability can be exhibited. In particular, even if high-speed release force of the separator of the present invention to the pressure-sensitive adhesive body described below is relatively small or the pressure-sensitive adhesive layer is relatively soft, the pressure-sensitive adhesive sheet of the present invention can exert excellent punching processability.

The separator of the present invention is not limited as long as the Young's modulus in the machine direction and the transverse direction, the breaking strength in the machine direction and the transverse direction, and the thickness are within the ranges. In detail, as the separator of the present invention, a separator in which the release layer is formed on at least one surface of the separator substrate, a low-adhesion separator made of a fluorine-based polymer and a low-adhesion separator made of a non-polarity polymer may be used. From the viewpoint of easy control of a mechanical property of the separator, the separator in which the release layer is formed on at least one surface of a separator substrate is preferable among the separators.

The separator substrate is not particularly limited, but a plastic film may be used. As the plastic film, examples thereof include: a plastic film made of a polyester-based resin such as polyethylene terephthalate (PET), polyethylene naphthalate (PEN) and polybutylene terephthalate (PBT); a plastic film made of an olefin based resin containing, as a monomer component, α-olefin such as polyethylene (PE), polypropylene (PP), polymethylpentene (PMP), ethylene-propylene copolymer and ethylene-vinyl acetate copolymer (EVA); a plastic film made of polyvinyl chloride (PVC); a plastic film made of a vinyl acetate based resin; a plastic film made of polycarbonate (PC); a plastic film made of polyphenylene sulfide (PPS); a plastic film made of an amide based resin such as polyamide (nylon) and wholly aromatic polyamide (aramid); a plastic film made of a polyimide based resin; a plastic film made of polyether ether ketone (PEEK). From the viewpoint of mechanical strength and elasticity, a plastic film composed of polyester-based resins is preferable, and a PET film is more preferable.

The Young's modulus in a machine direction of the separator substrate is not particularly limited, but is preferably 2 to 10 GPa, and more preferably 2 to 8 GPa. The Young's modulus in a transverse direction of the separator substrate is not particularly limited, but is preferably 2 to 10 GPa, and more preferably 2 to 8 GPa. When at least one of the Young's modulus in a machine direction and the Young's modulus in a transverse direction is less than 2 GPa, elasticity of the separator may be weak, and thus, punching processability may be deteriorated or release workability may be decreased. The Young's modulus can be measured by a tensile test in accordance with JIS K7113 in the same manner as the measurement of the Young's modulus of the separator.

The breaking strength in a machine direction of the separator substrate is not particularly limited, but is preferably 50 to 400 MPa, and more preferably 100 to 350 MPa. The breaking strength in a transverse direction of the separator substrate is not particularly limited, but is preferably 50 to 400 MPa, and more preferably 100 to 350 MPa. When at least one of the breaking strength in a machine direction and the breaking strength in a transverse direction is more than 400 MPa, insertion of a blade into the separator may be deteriorated, and thus, punching processability may be deteriorated. When at least one of the breaking strength in a machine direction and the breaking strength in a transverse direction is less than 50 MPa, in the case where the blade is inserted into the separator, the separator may be bent too much, and thus, punching processability may be deteriorated. The breaking strength can be measured in accordance with JIS Z0237 in the same manner as the measurement of the breaking strength of the separator.

The thickness of the separator substrate is not particularly limited, but is preferably 70 μm or more and 250 μm or less, and more preferably 70 μm or more and 150 μm or less. If the thickness is more than 250 μm, the blade may not be inserted. If the thickness is less than 70 μm, elasticity of the separator may be weak, and thus, punching processability may be deteriorated or release workability may be deteriorated.

The release layer formed on at least one surface of the separator substrate is not particularly limited, but the release layer formed of the release treating agent is preferable. The release treating agent is not particularly limited, and examples thereof include a silicon-based release treating agent, a fluorine-based release treating agent, a long-chain alkyl-based release treating agent and molybdenum sulfide. From the view point of easily controlling the high-speed release force, the silicon-based release treating agent is preferably used. The release treating agent may be used either alone or in combination of two or more thereof. The release layer may be a single layer or a multilayer structure of two layers or more, so long as it does not impair characteristics of the present invention.

The silicon-based release treating agent is not particularly limited, but a known/general silicon-based release treating agent may be used. More particularly, the silicon-based treating agent may be properly selected from commercially available thermosetting silicon-based release treating agents and ultraviolet-curing silicon-based release treating agents.

When the separator of the present invention includes the release layer which is formed of the silicon-based release treating agent on at least one surface of the separator substrate, the silicon-based release treating agent, which satisfies all of the above characteristics, and the high-speed release force to be described below as an index such as a kind of silicon-based release treating agent or a thickness (coated amount) of the release layer according to the pressure-sensitive adhesive layer, may be properly selected. Similarly, as the separator of the present invention, a separator which satisfies all of the above characteristics and the high-speed release force to be described below may be properly selected from commercially available separators and used.

The separator of the present invention may be manufactured by a known/general method and for example, may be manufactured by a method of forming the release layer on at least one side of the separator substrate. The separator of the present invention may include a layer other than the release layer (for example, an intermediate layer, a lower-coated layer or the like), so long as it does not impair the effect of the present invention.

(Other Separator)

As described above, in the case where the pressure-sensitive adhesive sheet of the present invention is the double-sided pressure-sensitive adhesive sheet, the pressure-sensitive adhesive sheet may include other separator other than the separator of the present invention. The other separator is not particularly limited and any known/general separator may be used. For example, a separator in which the release layer is formed on at least one surface of the separator substrate, a low-adhesion separator made of a fluorine-based polymer, a low-adhesion separator made of a non-polarity polymer and the like may be used. As the separator in which the release layer is formed on at least one surface of the separator substrate, examples thereof include a plastic film or a paper which is subjected to surface treatment by a release treating agent such as silicon-based release treating agent, long-chain alkyl-based release treating agent, fluorine-based release treating agent and molybdenum sulfide. The fluorine-polymer is not particularly limited, and examples thereof include polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer and the like. The non-polarity polymer is not particularly limited, and examples thereof include an olefin-based resin such as polyethylene (PE) and polypropylene (PP).

(Pressure-Sensitive Adhesive Body)

The pressure-sensitive adhesive body included in the pressure-sensitive adhesive sheet of the present invention may be a pressure-sensitive adhesive body having pressure-sensitive adhesive surfaces on both surfaces (double-sided pressure-sensitive adhesive body) and a pressure-sensitive adhesive body having a pressure-sensitive adhesive surface on only one surface (single-sided pressure-sensitive adhesive body), as described above. The pressure-sensitive adhesive body may be a “substrateless type pressure-sensitive adhesive body” that does not have a substrate or a “pressure-sensitive adhesive body with a substrate” that has a substrate (substrate layer). The substrateless type pressure-sensitive adhesive body may be, for example, a pressure-sensitive adhesive body consisting of the pressure-sensitive adhesive layer (double-sided pressure-sensitive adhesive body) or the like. The pressure-sensitive adhesive body with the substrate may be, for example, a pressure-sensitive adhesive body with the pressure-sensitive adhesive layers on both sides of the substrate (double-sided pressure-sensitive adhesive body), a pressure-sensitive adhesive body with the pressure-sensitive adhesive layer on only one side of the substrate (single-sided pressure-sensitive adhesive body). Among the pressure-sensitive adhesive bodies, from the viewpoint of transparency, the substrateless type pressure-sensitive adhesive body (particularly, the pressure-sensitive adhesive body consisting of the pressure-sensitive adhesive layer) is preferable.

The thickness of the pressure-sensitive adhesive body is not particularly limited, but is preferably 6 to 250 μm, more preferably 12 to 175 μm, and particularly, more preferably 25 to 175 μm. When the thickness of the pressure-sensitive adhesive body is more than 250 μm, a lot of paste may stick out, and thus, punching processability may be deteriorated. If the thickness of the pressure-sensitive adhesive body is less than 6 μm, the step absorbability may be lowered.

The pressure-sensitive adhesive body preferably has high transparency. For example, total light transmittance in a visible light wavelength region is preferably 80% or more and more preferably 85% or more. When the total light transmittance is less than 80%, a bad influence may be exerted on an exterior of a laminated optical product or the like. A haze of the pressure-sensitive adhesive body is preferably 3% or less and more preferably 1.5% or less. When the haze is more than 3%, a bad influence may be exerted on an exterior of a laminated optical product or the like. The total light transmittance and the haze can be measured by using a haze meter (manufactured by Murakami Color Research Laboratory, trade name “HM-150”) in accordance with JIS K7361 (total light transmittance) and JIS K7136 (haze), respectively, by laminating the pressure-sensitive adhesive body to, for example, a slide glass (for example, total light transmittance of 91.8% and haze of 0.4%).

(Pressure-Sensitive Adhesive Layer)

A pressure-sensitive adhesive layer for forming the pressure-sensitive adhesive body is not particularly limited so long as a high-speed release force to be described below is within a predetermined range, and a known/general pressure-sensitive adhesive layer may be used.

The pressure-sensitive adhesive sheet of the present invention preferably includes a relatively soft pressure-sensitive adhesive layer, among the pressure-sensitive adhesive layers. This is because the soft pressure-sensitive adhesive layer has excellent step absorbability or durability which is particularly required as an optical use (for example, a use of laminating optical members, manufacturing of an optical product or the like). In the case where the known pressure-sensitive adhesive sheet includes the soft pressure-sensitive adhesive layer, the pressure-sensitive adhesive layer tends to be easily protruding from the cutting plane in the punching process, and thus, the punching processability tends to be remarkably deteriorated. On the other hand, in the case where the pressure-sensitive adhesive sheet of the present invention includes the soft pressure-sensitive adhesive layer, lift-off of the separator as described below is prevented and excellent punching processability is exhibited by using a predetermined separator (the separator of the present invention). The “step absorbability” means a characteristic that even if a step presents on the surface of an adherend, a pressure-sensitive adhesive layer of a pressure-sensitive adhesive sheet to be laminated is modified according to a shape of the step, and a bubble or lift-off does not occur at the step part. The “durability” means a characteristic that a defect in adhesive reliability such that a bubble or lift-off does not occur at the step part is not caused by a change with time or a high-temperature condition after lamination.

Storage elastic modulus at −30° C. of the pressure-sensitive adhesive layer (referred to as storage elastic modulus (−30° C.) in some cases) is not particularly limited, but is preferably 1.0×10⁴ to 1.0×10¹⁴ Pa, more preferably, 1.0×10⁴ to 1.0×10¹⁰ and much more preferably 1.0×10³ to 1.0×10⁹ Pa. When the storage elastic modulus (−30° C.) is less than 1.0×10⁴ Pa, the pressure-sensitive adhesive layer may be too soft, and the pressure-sensitive adhesive layer may easily protrude from the cutting plane in the punching process, and thus, the punching processability may be deteriorated. On the other hand, when the storage elastic modulus (−30° C.) is more than 1.0×10¹⁴ Pa, a bubble or the lift-off may occur as a defect of the step absorbability. The storage elastic modulus can be measured by “Advanced Rheometric Expansion System (ARES)” manufactured by Rheometric Scientific Co., Ltd. under conditions of a frequency of 1 Hz, a temperature of −70° C. to 200° C., and a rising-temperature rate of 5° C./min, by laminating a plurality of pressure-sensitive adhesive layers so as to have a thickness of about 1.5 mm of the pressure-sensitive adhesive layer.

The pressure-sensitive adhesive sheet of the present invention can have excellent punching processability, even if the pressure-sensitive adhesive layer is very soft (for example, the storage elastic modulus (−30° C.) is 1.0×10⁴ to 1.0×10⁹ Pa). This is because the pressure-sensitive adhesive layer is prevented from protruding by controlling the Young's modulus, the breaking strength, and the thickness of the separator of the present invention to the above ranges and controlling a high-speed release force to be described below to a predetermined range. In this case, the pressure-sensitive adhesive sheet of the present invention can have excellent step absorbability and durability in addition to good punching processability.

A gel fraction of the pressure-sensitive adhesive layer is preferably 40% to 95% (wt %), and more preferably 50% to 90%, from the viewpoint of workability and adhesive reliability. The gel fraction is measured as an insoluble matter of ethyl acetate, and in detail, as a weight fraction (unit; wt %) of an insoluble matter after the pressure-sensitive adhesive layer is immersed in ethyl acetate at 23° C. for 7 days to the sample before immersing. The gel fraction can be controlled by an adding amount of a crosslinking agent, a monomer composition of the acrylic polymer to be described below (for example, the content of a component B), molecular weight of the acrylic polymer or the like. When the gel fraction is less than 40%, the release may be easily generated in a high-temperature test and heat resistance may be deteriorated. On the other hand, when the gel fraction is more than 95%, the pressure-sensitive adhesive layer may be hard and initial adhesion may be lowered.

In detail, the gel fraction (a ratio of an insoluble matter in a solvent) is a value calculated by a method of measuring the gel fraction to be described below.

(Method of Measuring Gel Fraction)

About 0.1 g of the pressure-sensitive adhesive layer is taken from the pressure-sensitive adhesive sheet of the present invention, covered by a porous tetrafluoroethylene sheet having an average pore diameter of 0.2 μm (trade name “NTF1122” manufactured by Nitto Denko Corp.), followed by binding with a kite string, and the weight is measured and the weight is referred to as a weight before immersing. The weight before immersing is the total weight of the pressure-sensitive adhesive layer (the taken pressure-sensitive adhesive layer), the tetrafluoroethylene sheet, and the kite sting. The total weight of the tetrafluoroethylene sheet and the kite string is also measured and referred to as a bag weight.

Next, the pressure-sensitive adhesive layer which is covered by the tetrafluoroethylene sheet and bound with the kite string (hereinafter, referred to as a sample) is put in a container of 50 ml filled with ethyl acetate and left at 23° C. for 7 days. Thereafter, after taking out the sample (after the ethyl acetate treatment) from the container, the sample is moved in an aluminum cap, followed by drying in a dryer at 130° C. for 2 hours to remove ethyl acetate, and then a weight is measured and referred to as a weight after immersing.

Then, the gel fraction is calculated by the following formula.

Gel fraction(wt%)=(A−B)/(C−B)×100 (1)

In the formula (1), A is a weight after immersing, B is a bag weight, and C is a weight before immersing.

It is preferred that the pressure-sensitive adhesive layer has high transparency. For example, a total light transmittance in a visible light wavelength region is preferably 80.0% or more, and more preferably 91.0% or more. When the total light transmittance is less than 80.0%, a bad influence may be exerted on an exterior of a laminated optical product or the like. A haze of the pressure-sensitive adhesive layer is preferably 1.0% or less, and more preferably 0.8% or less. When the haze is more than 1.0%, a bad influence may be exerted on an exterior of a laminated optical product or the like. The total light transmittance and the haze can be measured by using a haze meter (trade name “HM-150” manufactured by Murakami Color Research Laboratory) in accordance with JIS K7361 (total light transmittance) and JIS K7136 (haze), respectively, by laminating the pressure-sensitive adhesive layer to, for example, a slide glass (for example, the total light transmittance of 91.8% and the haze of 0.4%).

A thickness of the pressure-sensitive adhesive layer is not particularly limited, but is preferably 6 to 250 μm, and more preferably 12 to 175 If the thickness of the pressure-sensitive adhesive layer is less than 6 μm, the sufficient step absorbability may not be acquired. When the thickness of the pressure-sensitive adhesive layer is more than 250 μm, the pressure-sensitive adhesive layer may easily protrude from the cutting plane in the punching process, and thus, punching processability may be deteriorated. In addition, an optical product manufactured by using the pressure-sensitive adhesive sheet of the present invention may be difficult to be miniaturized and made thinner. The pressure-sensitive adhesive layer may have any form of a single layer and a multilayer.

From the standpoint of an optical property such as transparency and weather resistance, the pressure-sensitive adhesive layer is preferably an acrylic pressure-sensitive adhesive layer including an acrylic polymer as a base polymer. In detail, as the acrylic pressure-sensitive adhesive layer, specific examples thereof include a pressure-sensitive adhesive layer formed from a pressure-sensitive adhesive composition (acrylic pressure-sensitive adhesive composition) including an acrylic polymer including alkoxyalkyl acrylate and an acrylic monomer including a crosslinkable functional group, to be described below, as an essential monomer component, and a crosslinking agent. In the case where the pressure-sensitive adhesive sheet of the present invention includes the acrylic pressure-sensitive adhesive layer, a high-speed release force of the separator of the present invention which is provided on the surface of the acrylic pressure-sensitive adhesive layer can be easily controlled to a predetermined range to be described below, and thus, the punching processability can be improved.

The content of the acrylic polymer in the pressure-sensitive adhesive composition is not particularly limited, but is preferably 65 wt % or more (for example, 65 to 100 wt %), and more preferably 70 to 99.999 wt % based on the solid content (100 wt %) of the pressure-sensitive adhesive composition. That is, the content of the acrylic polymer in the acrylic pressure-sensitive adhesive layer is not particularly limited, but is preferably 65 to 100 wt %, and more preferably 70 to 99.999 wt % based on the acrylic pressure-sensitive adhesive layer (100 wt %).

In detail, as the acrylic pressure-sensitive adhesive layer, specific examples thereof include a pressure-sensitive adhesive layer formed from a pressure-sensitive adhesive composition including an acrylic polymer having a weight-average molecular weight of 400,000 to 1,600,000, which includes, as an essential monomer component, alkoxyalkyl acrylate (hereinafter, referred to as a “component A” in some cases) and an acrylic monomer (hereinafter, referred to as a “component B” in some cases) including a crosslinkable functional group, and a crosslinking agent, in which the content of the component A is 20 to 99.5 wt % and the content of the component B is 0.1 to 4.5 wt % based on the all monomer components (100 wt %) constituting the acrylic polymer. In the case where a carboxyl group-containing monomer is not substantially included in the monomer components constituting the acrylic polymer, a pressure-sensitive adhesive sheet having excellent corrosion resistance to metal (including metal oxide), particularly, a metal thin film (including a metal oxide thin film) can be formed.

Hereinafter, the acrylic pressure-sensitive adhesive layer having the above described detailed configuration, which is formed from a pressure-sensitive adhesive composition including an acrylic polymer having a predetermined molecular weight which includes, as an essential monomer component, alkoxyalkyl acrylate and an acrylic monomer having a crosslinkable functional group, and a crosslinking agent, will be described in detail.

The pressure-sensitive adhesive composition, for forming the acrylic pressure-sensitive adhesive layer having the above-described detailed configuration, includes the acrylic polymer and crosslinking agent as essential components.

The acrylic polymer used hi the pressure-sensitive adhesive composition may be a polymer including alkoxyalkylester acrylate (alkoxyalkyl acrylate) (component A) as an essential monomer component. The acrylic polymer may include the acrylic monomer having a crosslinkable functional group (component B) as an essential copolymer monomer component, in addition to the above monomer component. If necessary, the acrylic polymer may include other monomer component(s).

The alkoxyalkylacrylate (component A) is not particularly limited, but for example, may be 2-methoxyethyl acrylate, 2-ethoxyethyl acrylate, methoxytriethylene glycol acrylate, 3-methoxypropyl acrylate, 3-ethoxypropyl acrylate, 4-methoxybutyl acrylate and 4-ethoxybutyl acrylate. The component A may be used either alone or in combination of two or more thereof. Among the components, from the standpoint of copolymerization and a coating property (viscosity) of the pressure-sensitive adhesive composition, 2-methoxyethyl acrylate (2MEA) and 2-ethoxyethyl acrylate are preferable.

The content of the component A is not particularly limited, but is preferably 20 to 99.5 wt %, and more preferably 50 to 80 wt % based on the entire monomer components (100 wt %) constituting the acrylic polymer. If the content of the component A is less than 20 wt %, adhesion may be insufficient and an anti-foam release property, which means a characteristic that a foam or a release (bubble or lift-off) is prevented from occurring at an adhesion interface between the pressure-sensitive adhesive layer and plastic under conditions of a high temperature or a high temperature and high humidity after laminating the pressure-sensitive adhesive sheet to the plastic, may be insufficient. On the other hand, if the content of the component A is more than 99.5 wt %, since the content of the component B is lowered, a crosslinked structure of the acrylic polymer when forming the acrylic pressure-sensitive adhesive layer may be insufficient, a crosslinking speed may be slow, or the anti-foam release property may be insufficient.

The crosslinkable functional group of the acrylic monomer (component B) is not particularly limited so long as the crosslinkable functional group reacts with a crosslinking agent to be described below and is capable of crosslinking the acrylic polymer. Examples thereof include a glycidyl group, an amino group, an N-methylolamide group and a hydroxyl group. In detail, for the component B, as a glycidyl group-containing monomer, examples thereof include glycidyl(meth)acrylate and glyoidylmethyl(meth)acrylate; as a amino group-containing monomer, examples thereof include N,N-dimethylaminoethyl(meth)acrylate and N,N-diethylaminoethyl(meth)acrylate; as a N-methylolamide group-containing monomer, examples thereof include N-methylol(meth)acrylamide; as a hydroxyl group-containing monomer, examples thereof include 2-hydroxylethyl(meth)acrylate, 3-hydroxylpropyl(meth)acrylate, 4-hydroxylbutyl(meth)acrylate and 6-hydroxylhexyl(meth)acrylate. Among the components, the monomers having N-methylolamide group and acrylic monomers having hydroxyl group are preferable, acrylic monomers having hydroxyl group are more preferable, and particularly, 2-hydroxylethylacrylate (2HEA), 4-hydroxylbutylacrylate (4HBA), 3-hydroxylpropylacrylate (3HPA), and 6-hydroxylhexylacrylate (6HHA) are more preferable. The “(meth)acryl” means “acryl” and/or “methacryl” and is the same as described below.

The content of the component B is not particularly limited, but is preferably 0.1 to 4.5 wt %, more preferably, 0.5 to 3.0 wt %, and much more preferably 0.5 to 2.0 wt % based on the entire monomer components (100 wt %) constituting the acrylic polymer. If the content of the component B is less than 0.1 wt %, a crosslinked structure of the acrylic polymer may be insufficient when forming the acrylic pressure-sensitive adhesive layer and durability may be deteriorated. In addition, the acrylic pressure-sensitive adhesive layer may be too soft, and thus, the punching processability may be deteriorated. On the other hand, if the content of the component B is more than 4.5 wt %, the crosslinked structure may be very dense and the storage elastic modulus (−30° C.) or storage elastic modulus at room temperature of the pressure-sensitive adhesive layer may be too high, and thus; step absorbability may be deteriorated.

It is preferred that the monomer component constituting the acrylic polymer does not substantially include a monomer including a carboxyl group (carboxyl group-containing monomer). In this case, when the pressure-sensitive adhesive sheet of the present invention is laminated to the metal thin film, corrosion resistance is excellent. The “does not substantially include” means that the carboxyl group-containing monomer is not actively incorporated except for the case where the carboxyl group-containing monomer is inevitably mixed. In detail, the content of the carboxyl group-containing monomer is not particularly limited, but is preferably 0.05 wt % or less, more preferably, 0.01 wt % or less, and much more preferably 0.001 wt % or less based on the entire monomer components (100 wt %) constituting the acrylic polymer. In the case where the carboxyl group-containing monomer is included (for example, the content is more than 0.05 wt %), corrosion resistance to the metal thin film may be deteriorated (for example, conductive performance of an ITO (indium thin oxide) film may be deteriorated). As the carboxyl group-containing monomer, examples thereof include acrylic acid (AA), methacrylic acid, itaconic acid, maleic acid, fumaric acid and crotonic acid. Acid anhydride of the carboxyl group-containing monomers (for example, an acid anhydride group-containing monomer such as maleic anhydride and itaconic anhydride) is also included in the carboxyl group-containing monomer.

In the acrylic polymer, as the other monomer component other than the component A and component B, examples thereof include alkylester (meth)acrylate having a linear or branched alkyl group having 1 to 12 carbon atoms such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate and dodecyl (meth)acrylate. In addition thereto, examples thereof include methacrylate alkoxyalkylester such as methoxyethyl methacrylate and ethoxyethyl methacrylate; (meth)acrylate ester having an alicyclic hydrocarbon group, such as cyclopentyl (meth)acrylate, cyclohexyl (meth)acrylate and isobornyl (meth)acrylate; (meth)acrylate ester having an aromatic hydrocarbon group, such as phenyl(meth)acrylate, phenoxyethyl(meth)acrylate and benzyl(meth)acrylate; vinyl esters such as vinyl acetate and vinyl propionate; aromatic vinyl compounds such as styrene and vinyl toluene; olefins or dienes such as ethylene, butadiene, isoprene and isobutylene; vinyl ethers such as vinylalkyl ether; vinyl chloride.

As the above other monomer component, examples thereof include a multifunctional monomer, for example, hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxyacrylate, polyesteracrylate and uretaneacrylate.

As the above other monomer component, a monomer having preferably Tg of 0° C. or less, more preferably Tg of −40° C. or less, and much more particularly Tg of −50° C. or less, when made into a homopolymer, inform the standpoint that glass transition temperature Tg of the acrylic polymer is controlled to lower level and the storage elastic modulus (−30° C.) or storage elastic modulus at room temperature of the pressure-sensitive adhesive layer is controlled to lower level. For example, the other monomer component is preferably 2-ethylhexylacrylate (2EHA), butylacrylate (BA), and isooctylacrylate (iOA), and more preferably 2-ethylhexylacrylate (2EHA) and isooctylacrylate (iOA).

The content of the above other monomer component is not particularly limited, but is preferably 20 to 79 wt %, and more preferably 20 to 70 wt % based on the entire monomer components (100 wt %) constituting the acrylic polymer. If the content is less than 20 wt %, the step absorbability may be deteriorated. On the other hand, if the content is more than 79 wt %, the anti-foam release property may be deteriorated.

The acrylic polymer may be manufactured by polymerizing the monomer components using a known/general polymerization method. As the polymerization of the acrylic polymer, examples thereof include a solution polymerization, an emulsion polymerization, a bulk polymerization, a polymerization by an active energy-ray irradiation (active energy-ray polymerization) or the like. Among the polymerization, the solution polymerization and the active energy-ray polymerization, and more preferably the solution polymerization may be used from the standpoint of transparency, water resistance, cost or the like.

A polymerization initiator used in the solution polymerization of the acrylic polymer is not particularly limited and may be properly selected from known/general initiators and used. For example, examples thereof include an oil-soluble polymerization initiator, such as an azo-based polymerization initiator such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane) and dimethyl-2,2′-azobis(2-methylpropionate); and a peroxide-based polymerization initiator such as benzoylperoxide, t-butylhydroperoxide, di-t-butylperoxide, t-butylperoxybenzoate, dicumylperoxide, 1,1-bis(t-butylperoxy)3,3,5-trimethylcyclohexane and 1,1-bis(t-butylperoxy)cyclododecane. The polymerization initiator may be used either alone or in combination of two or more thereof. The amount of the polymerization initiator used may be generally used amount and for example, may be selected in the range of about 0.01 to 1 part by weight based on the entire monomer components (100 parts by weight) constituting the acrylic polymer.

In the solution polymerization, various kinds of general solvents may be used. As the solvents, examples thereof include organic solvents, such as esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

A weight average molecular weight (Mw) of the acrylic polymer is not particularly limited, but is preferably 400,000 to 1,600,000, more preferably 600,000 to 1,200,000, and much more preferably 600,000 to 1,000,000. If the weight average molecular weight (Mw) of the acrylic polymer is less than 400,000, pressure-sensitive adhesion force and cohesion force required as the pressure-sensitive adhesive layer may not be acquired and durability may be deteriorated. The anti-foam release property may also be deteriorated. On the other hand, if the weight average molecular weight is more than 1,600,000, a defect in a coating property due to a viscosity increase of the pressure-sensitive adhesive composition may be caused. The weight average molecular weight of the acrylic polymer can be controlled by a kind or used amount of the polymerization initiator, a temperature or time at polymerization, a monomer concentration, a monomer dropping rate or the like.

In the present invention, the weight average molecular weight (Mw) of the acrylic polymer can be measured by a gel permeation chromatography (GPC). In detail, the weight average molecular weight (Mw) of the acrylic polymer can be determined with a polystyrene conversion value and by using a GPC measuring device, a trade name of “HLC-8120 GPC” (manufactured by Tosoh Corporation) under the following measuring conditions of GPC.

Measuring Conditions of GPC
Sample concentration: 0.2 wt % (tetrahydrofuran solution)
Sample injection amount: 10 μL
Eluent: tetrahydrofuran (THF)
Flow amount (flow rate): 0.6 mL/min
Column temperature (measuring temperature): 40° C.
Column: trade name “TSKgelSuperHM-H/H4000/H3000/H2000” (manufactured by Tosoh Corporation)
Detector: Refractive Index (RI) detector

The glass transition temperature (Tg) of the acrylic polymer is preferably −70° C. to −40° C., and more preferably −70° C. to −50° C., from the standpoint that the storage elastic modulus (−30° C.) or storage elastic modulus at room temperature of the pressure-sensitive adhesive layer is controlled to lower level, thereby improving a pressure-sensitive adhesion property at a low temperature or a characteristic at a high speed (for example, a characteristic without causing release when a laminated structure is dropped (drop impact)). If the glass transition temperature is less than −70° C., the acrylic pressure-sensitive adhesive layer may be too soft, and thus, the punching processability may be deteriorated. The anti-foam release property may also be deteriorated. On the other hand, if the glass transition temperature is more than −40° C., the acrylic pressure-sensitive adhesive layer may be too hard, and thus, the pressure-sensitive adhesive force may be deteriorated. The glass transition temperature of the acrylic polymer can be controlled by a kind or content of the other monomer constituting the acrylic polymer.

The glass transition temperature (Tg) of the acrylic polymer is a glass transition temperature (theoretical value) represented by the following equation.

1/Tg=W₁/Tg₁+W₂/Tg₂+ . . . +Wₙ/Tgₙ

In the above equation, Tg represents a glass transition temperature (unit: K) of the acrylic polymer, Tgᵢ represents a glass transition temperature (unit: K) when a monomer i forms a homopolymer, and Wᵢ represents a weight fraction of the monomer i (i=1, 2, . . . n) in the entire monomer components. The equation is an equation in the case where the acrylic polymer is configured by n kinds of monomer components such as monomer 1, monomer 2, . . . , monomer n.

The crosslinking agent as an essential component of the pressure-sensitive adhesive composition for forming the pressure-sensitive adhesive layer crosslinks a polymer which is a main component of the pressure-sensitive adhesive layer, that is, a base polymer (for example, the acrylic polymer), and the durability and anti-foam release property of the pressure-sensitive adhesive layer can be improved. The crosslinking agent used may be known/general and is not particularly limited, but may be properly selected from a multifunctional melamine compound (melamine-based crosslinking agent), a multifunctional epoxy compound (epoxy-based crosslinking agent) and a multifunctional isocyanate compound (isocyanate-based crosslinking agent), and used. The crosslinking agent may be used either alone or in combination of two or more thereof.

As the multifunctional melamine compound, examples thereof include methylated trimethylol melamine and butylated hexamethylol melamine. As the multifunctional epoxy compound, examples thereof include diglycidyl aniline and glycerin diglycidyl ether. As the multifunctional isocyanate compound, examples thereof include tolylene diisocyanate (TDI), hexamethylene diisocyanate (HDI), polymethylene polyphenyl isocyanate, diphenylmethane diisocyanate, a reaction product of trimethylol propane with tolylene diisocyanate, a reaction product of trimethylol propane with hexamethylene diisocyanate, polyether polyisocyanate, and polyester polyisocyanate. Among the crosslinking agents, it is preferred to use the multifunctional isocyanate compound (isocyanate-based crosslinking agent) as the crosslinking agent, and the monomer containing a hydroxyl group as the component B.

According to a use of the pressure-sensitive adhesive sheet, there are some cases where a yellowing prevention of the pressure-sensitive adhesive layer is rigidly required. For example, in the case where the aromatic isocyanate compound (aromatic isocyanate-based crosslinking agent) is used as the crosslinking agent, the yellowing may become a problem, and a countermeasure thereto may be needed. In this case, particularly, in order to improve yellowing resistance (yellowing prevention), it is preferred that an aliphatic isocyanate compound (aliphatic isocyanate-based crosslinking agent) is used among them. The widely know aliphatic isocyanate-based crosslinking agent may be used, but preferable examples thereof include 1,6-hexamethylene diisocyanate, 1,4-tetramethylene diisocyanate, 2-methyl-1,5′-pentane diisocyanate, 3-methyl-1,5-pentane diisocyanate, lysine diisocyanate, isophorone diisocyanate, cyclohexyl diisocyanate, hydrogenated tolylene diisocyanate, hydrogenated xylene diisocyanate, hydrogenated diphenylmethane diisocyanate and hydrogenated tetramethylxylene diisocyanate. Among the crosslinking agents, it is preferred to use hexamethylene diisocyanate (1,6-hexamethylene diisocyanate) (also, including the reaction product using HDI) as the crosslinking agent, and the monomer containing a hydroxyl group as the component B.

The content of the crosslinking agent in the pressure-sensitive adhesive composition is not particularly limited, but is preferably 0.01 to 5 parts by weight, more preferably, 0.01 to 3 parts by weight, much more preferably, 0.1 to 3 parts by weight, and most preferably, 0.1 to 1 part by weight based on the entire monomer components (100 parts by weight) constituting the acrylic polymer. In particular, in order to improve yellowing resistance of the pressure-sensitive adhesive layer, the content of the aliphatic isocyanate-based crosslinking agent is preferably 0.01 to 3 parts by weight, more preferably, 0.1 to 3 parts by weight, and much more preferably 0.1 to 1 part by weight based on the entire monomer components (100 parts by weight) constituting the acrylic polymer.

As described above, in the case where the aliphatic isocyanate-based crosslinking agent is used in order to prevent the yellowing, a crosslinking speed may become very slow, and thus a problem in productivity may be generated. In a general pressure-sensitive adhesive sheet, a crosslinking reaction may be accelerated by heating, but in a use requiring a strict appearance, the method of accelerating the crosslinking by heating may be difficult to be employed because a dent is liable to be generated or promoted. In this case, in order to accelerate the crosslinking reaction, in the pressure sensitive adhesive composition, an amine-based compound containing a plurality of hydroxyl groups may be used as the crosslinking accelerator. In the case where the aliphatic isocyanate-based crosslinking agent is used as the crosslinking agent, in order to maintain productivity (particularly, even though the crosslinking is not accelerated by the heating, the crosslinking reaction is rapidly progressed), the amine-based compound may be particularly used together. The amine-based compound containing the plurality of hydroxyl groups is not particularly limited so long as the amine-based compound has at least two hydroxyl groups (alcoholic hydroxyl groups) in the molecules. The number of nitrogen atoms contained in the molecules of the amine-based compound is not also particularly limited. The amine-based compound containing the plurality of hydroxyl groups may be used either alone or in combination of two or more thereof.

In detail, for the amine-based compound containing the plurality of hydroxyl groups as an amine-based compound having one nitrogen atom in the molecule, examples thereof include dialcohol amines such as diethanolamine, dipropanolamine, diisopropanolamine, N-methyldiethanolamine, N-methyldiisopropanolamine, N-ethyldiethanolamine, N-ethyldiisopropanolamine, N-butyldiethanolamine and N-butyldiisopropanolamine; and trialcoholamines such as triethanolamine, tripropanolamine and triisopropanolamine.

As the amine-based compound having two nitrogen atoms in the molecule, an amine-based compound represented by the following formula (I) may be exemplified.

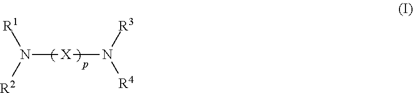

In the formula (I), R¹, R², R³, and R⁴ are the same as or different from each other and each of them represents a hydrogen atom or [—(R⁵O)ₘ(R⁶O)ₙ—H]. Herein, R⁵ and R⁶ are different from each other and each represents an alkylene group. m and n are an integer of 0 or more and both m and n do not represent 0 at the same time. Two or more of R¹, R², R³, and R⁴ are [—(R⁵O)ₘ(R⁶O)ₙ—H]. X is a divalent hydrocarbon group and p is an integer of 1 or more.

In the formula (I), the alkylene groups of R⁵ and R⁶ may be an alkylene group having about 1 to 6 carbon atoms (preferably, an alkylene group having 1 to 4 carbon atoms, and more preferably an alkylene group having 2 or 3 carbon atoms) such as methylene group, ethylene group, propylene group, trimethylene group, tetramethylene group, ethylethylene group, pentamethylene group and hexamethylene group. The alkylene group may be straight or branched. Among the alkylene groups, the alkylene groups of R⁵ and R⁶ is preferably an ethylene group and a propylene group.

So long as m and n are an integer of 0 or more, m and n are not particularly limited, but at least one of m and n may be selected from the range of 0 to 20, preferably 1 to 10. In many cases, either of m and n is 0 and the other is an integer of 1 or more (particularly, 1). Both of m and n are not 0 at the same time (when both m and n are 0 at the same time, [—(R⁵O)ₘ(R⁶O)ₙ—H] represents a hydrogen atom).

X represents a divalent hydrocarbon group. As the divalent hydrocarbon group, examples thereof include an alkylene group, a cycloalkylene group and an arylene group. The alkylene group of X may be straight or branched. X may be saturated or unsaturated. The alkylene groups of X may be an alkylene group having about 1 to 6 carbon atoms (preferably an alkylene group having 1 to 4 carbon atoms, and more preferably an alkylene group having 2 or 3 carbon atoms) such as methylene group, ethylene group, propylene group, trimethylene group and tetramethylene group. As the cycloalkylene group, examples thereof include a cycloalkylene group having 5- to 12-membered ring, such as a 1,2-cyclohexylene group, a 1,3-cyclohexylene group and a 1,4-cyclohexylene group. As the arylene group, examples thereof include a 1,2-phenylene group, a 1,3-phenylene group and a 1,4-phenylene group.

p is not particularly limited so long as p is an integer of 1 or more, but may be selected from the range of an integer of 1 to 10, preferably 1 to 6, and more particularly 1 to 4.

In more detail, as the amine-based compound represented by the formula (I), examples thereof include N,N,N′,N′-tetrakis(2-hydroxyethyl)ethylenediamine, N,N,N′,N′-tetrakis(2-hydroxylpropyl)ethylenediamine, N,N,N′,N′-tetrakis(2-hydroxyethyl)trimethylenediamine and N,N,N′,N′-tetrakis(2-hydroxypropyl)trimethylenediamine, as well as polyoxyalkylene condensates of alkylenediaimine such as polyoxyethylene condensates of ethylenediamine, polyoxypropylene condensates of ethylenediamine and polyoxyethylene-polyoxypropylene condensates of ethylenediamine. As the amine-based compound, commercially available products such as trade names of “EDP-300”, “EDP-450”, “EDP-1100”, and “Pluronic” (manufactured by ADEKA Corp.) may be used.

The content of the amine-based compound containing the plurality of hydroxyl groups is preferably 0.01 to 5.0 parts by weight, and more preferably 0.05 to 1.0 part by weight based on the entire monomer components (100 parts by weight) constituting the acryl-based polymer, in order to accelerate the crosslinking reaction and improve the productivity.

In order to accelerate the crosslinking reaction, a crosslinking accelerator in addition to the compounds described above may be included in the pressure-sensitive adhesive composition. As the crosslinking accelerator, examples thereof include an amino compound such as N,N,N′,N′-tetramethylhexanediamine and imidazole; an amine compound having a plurality of reactive functional groups other than the hydroxyl group; and an organic metallic compound such as cobalt naphthenate, dibutyl tin diacetate, dibutyl tin hydroxide and dibutyl tin laurate. The crosslinking accelerators may be used either alone or in combination of two or more thereof. Generally, the content of the crosslinking accelerator is preferably 0.001 to 0.5 parts by weight, and more preferably 0.001 to 0:3 parts by weight based on the entire monomer components (100 parts by weight) constituting the acryl-based polymer.

In the pressure-sensitive adhesive composition, general other additives, that is, tackifying resins (such as rosin derivative, polyterpene resin, petroleum resin and oil soluble phenol), an anti-aging agent, a filler, a colorant (such as pigment and dye), an ultraviolet absorber, an antioxidant, a chain transfer agent, a plasticizer, a softener, a surfactant and an antistatic agent may be used, if necessary, so long as the additives do not impair the characteristics of the present invention. When forming of the pressure-sensitive adhesive layer, various kinds of general solvents may be used. A kind of the solvent is not particularly limited and the above-exemplified solvents used in the solution polymerization may be used.

The pressure-sensitive adhesive composition (preferably, the acrylic pressure-sensitive adhesive composition) may be prepared by mixing the polymer (for example, an acrylic polymer), the crosslinking agent, and if necessary, the crosslinking accelerator or other additives.

The pressure-sensitive adhesive layer may be prepared by coating the pressure-sensitive adhesive composition on a substrate or a separator (for example, the separator of the present invention) and, if necessary, drying and/or curing. The double-sided pressure-sensitive adhesive sheet including the substrateless pressure-sensitive adhesive body consisting of the pressure-sensitive adhesive layer may be prepared by coating the pressure-sensitive adhesive composition on the separator (for example, the separator of the present invention).

The pressure-sensitive adhesive composition may be coated by a known coating method and using a general coater, for example, a gravure roll coater, a reverse roll coater, a kiss roll coater, a dip roll coater, a bar coater, a knife coater and a spray coater.

(Substrate)

In the case where the pressure-sensitive adhesive body constituting the pressure-sensitive adhesive sheet of the present invention is the pressure-sensitive adhesive body with a substrate, the substrate is not particularly limited, but may be selected from various kinds of optical films such as a plastic film, an anti-reflective (AR) film, a polarizer and a retardation film. As materials of the plastic film, examples thereof include polyester resins such as polyethylene terephthalate (PET); acrylic resins such as polymethylmethacrylate (PMMA); cyclic olefin polymers such as polycarbonate, triacetylcelluous (TAC), polysulfone, polyarylate, polyimide, polyvinylchloride, polyvinylacetate, polyethylene, polypropylene, ethylene-propylene copolymer, trade name “Arton (cyclic olefin polymer; manufactured by JSR)” and trade name “Zeonor (cyclic olefin polymer; manufactured by Nippon Zeon)”. The plastic materials may be used either alone or in combination of two or more thereof. The “substrate” is a part laminated to an adherend together with the pressure-sensitive adhesive layer, when the pressure-sensitive adhesive sheet is used (laminated) to the adherend (an optical member). The separator released in the use (lamination) of the pressure-sensitive adhesive sheet is not included in the “substrate”.

Among them, the substrate is preferably a transparent substrate. For example, the “transparent substrate” means a substrate having a total light transmittance in a visible wavelength region of preferably 85.0% or more, and more preferably 88.0% or more. A haze of the substrate is preferably 1.5% or less, and more preferably 1.0% or less.

A thickness of the substrate is not particularly limited, but for example, is preferably 12 to 75 μm. The substrate may have a single layer form or multilayer form. On the surface of the substrate, a known/general surface treatment, for example, a physical treatment such as a corona discharge treatment and a plasma treatment, and a chemical treatment such as a basecoat treatment, may be properly preformed.

(Pressure-Sensitive Adhesive Sheet of the Present Invention)

The pressure-sensitive adhesive sheet of the present invention includes the separator of the present invention on at least one side of the pressure-sensitive adhesive body. In the pressure-sensitive adhesive sheet of the present invention, a release force (high-speed release force) of the separator (the separator of the present invention) to the pressure-sensitive adhesive body in a 180° peel test at a tensile speed of 30 m/min is 0.8 N/50 mm or more (for example, 0.8 to 5.0 N/50 mm), preferably 1.4 to 3.0 N/50 mm, and more preferably 1.4 to 2.0 N/50 mm. If the high-speed release force is less than 0.8 N/50 mm, lift-off of the separator may easily occur in the punching process, and thus, punching processability may be deteriorated. On the other hand, if the high-speed release force is more than 5.0 N/50 mm, a problem (problem in which release can not be performed) may occur in the manufacturing process. As described above, the “high-speed release force” of the separator of the present invention means a 180° peeling pressure-sensitive adhesive force of the separator to the pressure-sensitive adhesive body, which is measured by a 180° peel test (in accordance with JIS Z0237) at a tensile speed of 30 m/min.

The high-speed release force may be controlled by appropriately selecting a kind of release treating agent of the separator and a thickness (coating amount) of the release layer, according to the pressure-sensitive adhesive layer.

In the known pressure-sensitive adhesive sheet, when the high-speed release force of the separator is small, lift-off of the separator easily occurs, and thus, punching processability is deteriorated. On the other hand, even if the high-speed release force is particularly small (for example, 0.8 to 1.5 N/50 mm), the pressure-sensitive adhesive sheet of the present invention can have excellent punching processability. This is because lift-off of the separator of the present invention can be prevented in the punching process by controlling the Young's modulus, the breaking strength, and the thickness of the separator of the present invention to the above range. Accordingly, in the pressure-sensitive adhesive sheet of the present invention, a separator having a release force (high-speed release force) in the broader range can be selected as the separator of the present invention, and its generality is high.

The pressure-sensitive adhesive sheet of the present invention is an optical pressure-sensitive adhesive sheet used in laminating the optical members or manufacturing the optical product. It is preferred that the pressure-sensitive adhesive sheet of the present invention is an optical pressure-sensitive adhesive sheet used after the punching process. The optical member means a member having an optical characteristic (for example, a polarized property, a photorefractive property, a light scattering property, a light reflective property, a light transmitting property, a light absorbing property, a light diffraction property, an optical rotation property and a visibility). The optical member is not particularly limited so long as the optical member is the member having the optical characteristic, and examples thereof include a member constituting an optical product such as a display device (image display device) or an input device, or a member used for the devices (optical products). For example, examples thereof include a polarizer, a wave plate, a retardation plate, an optical compensation film, a brightness enhancing film, a light guide plate, a reflective film, an anti-reflective film, a transparent conductive film (ITO film, etc.), a design film, a decoration film, a surface protective film, a prism, lens, a color filter, a transparent substrate, and a member in which these are laminated (all are also called “a functional film” in some cases). The “plate” and the “film” include plate form, film form and sheet form, and for example, the “polarizing film” includes a “polarizing plate” and a “polarizing sheet”. The “functional film” includes a “functional plate” and a “functional sheet”.

As the display device, examples thereof include a liquid crystal display, an organic electro luminance (EL) display, a plasma display panel (PDP) and an electronic paper. As the input device, examples thereof include a touch panel.

The optical member is not particularly limited, and examples thereof include a member formed of an acryl resin, polycarbonate, polyethylene terephthalate, glass and a metal thin film (for example, a sheet, film, or plate type of member). As described above, the “optical member” of the present invention also includes a member (such as a design film, a decoration film or a surface protective film) for decoration or protection while maintaining visibility of the display device or input device as an adherend.

An embodiment of the optical member laminated by the pressure-sensitive adhesive sheet of the present invention is not particularly limited, but examples thereof include (1) an embodiment in which the optical members are laminated through the pressure-sensitive adhesive sheet of the present invention, (2) an embodiment in which the optical member and a member other than the optical member are laminated through the pressure-sensitive adhesive sheet of the present invention, or (3) an embodiment in which the pressure-sensitive adhesive sheet of the present invention including the optical member is laminated to the optical member or the member other than the optical member. In the case of the embodiment (1) or (2), it is preferred that the pressure-sensitive adhesive sheet of the present invention is a double-sided pressure-sensitive adhesive sheet, and in the case of the embodiment (3), the pressure-sensitive adhesive sheet of the present invention may be a single-sided pressure-sensitive adhesive sheet or a double-sided pressure-sensitive adhesive sheet. In the ease of the embodiment (3), it is preferred that the pressure-sensitive adhesive sheet of the present invention is a pressure-sensitive adhesive sheet including the optical member (the optical film such as the polarizing film) as the substrate.

In the case where the pressure-sensitive adhesive sheet of the present invention is used to be directly laminated to a metal thin film (including a metal oxide thin film of ITO (indium tin oxide), ZnO, SnO, CTO (cadmium tin oxide) and the like) of the transparent conductive film or the like, the pressure-sensitive adhesive sheet excellent in corrosion resistance, which includes the acrylic pressure-sensitive adhesive layer formed from the pressure-sensitive adhesive composition including the acrylic polymer which is configured by monomer components in which the carboxyl group-containing monomer is not substantially included, is preferable.

As described above, since the pressure-sensitive adhesive sheet of the present invention has excellent punching processability, the pressure-sensitive adhesive sheet is preferably used after performing the punching process in a desired shape, In the case where the pressure-sensitive adhesive sheet of the present invention is the single-sided pressure-sensitive adhesive sheet, from the standpoint of the manufacturing process, a punching blade is preferably inserted from a side opposite to the separator of the present invention (that is, the substrate side) in the punching process. On the other hand, in the case where the pressure-sensitive adhesive sheet of the present invention is the double-sided pressure-sensitive adhesive sheet, a punching blade is preferably inserted from a side opposite to the separator of the present invention in the punching process.

In the known pressure-sensitive adhesive sheet, when the separator is released from the pressure-sensitive adhesive sheet after the punching process, there is a problem in a defect of punching processability such as the “adhesive stretch” in which a part of the pressure-sensitive adhesive layer is stretched in a thread shape or the “adhesive omission” in which a part of the pressure-sensitive adhesive layer is attached to the separator side and the pressure-sensitive adhesive layer is omitted. The defects are caused because the pressure-sensitive adhesive layer protrudes from the cutting plane in the punching process and the protruding pressure-sensitive adhesive layer is attached to the edge face of the separator. It is assumed that the protruding pressure-sensitive adhesive layer is generated because the local lift-off of the separator (the phenomenon in which the separator is partially released from the pressure-sensitive adhesive layer) occurs in the punching processing and as a result, the pressure-sensitive adhesive layer is easy to be deformed. It is assumed that the lift-off of the separator is generated because elasticity of the separator of the known pressure-sensitive adhesive sheet is weak and the high-speed release force is low (for example, 0.6 N/50 mm or less). The deformation of the pressure-sensitive adhesive layer is significantly generated when the pressure-sensitive adhesive layer is soft and in this case, the punching processability tends to be further deteriorated.

In the present invention, in the pressure-sensitive adhesive sheet including the separator provided on at least one surface of the pressure-sensitive adhesive body, the punching processability can be improved by controlling the Young's modulus, breaking strength, and thickness of the separator and controlling a high-speed release force of the separator to the pressure-sensitive adhesive body to 0.8 N/50 mm or more. It is assumed that these effects are achieved because distortion of the separator is decreased and the lift-off is prevented in the punching process by reinforcing elasticity of the separator; and a bending of the pressure-sensitive adhesive sheet forms an obtuse angel in the punching process, and thus, the pressure-sensitive adhesive layer can be easily inserted to the inside of the cutting plane. Accordingly, even in the case where the punching processability is deteriorated in the related art, in detail, the relatively soft pressure-sensitive adhesive layer is included or the high-speed release force of the separator is relatively small, the pressure-sensitive adhesive sheet of the present invention can have excellent punching processability. In this case, the pressure-sensitive adhesive sheet of the present invention can have excellent step absorbability and durability in addition to the excellent punching processability. In the manufacturing process, an application range can be widely set in the case of changing a release angle of the separator or the like, or the workability can be excellent when the separator is released from the pressure-sensitive adhesive sheet after the punching process.

### EXAMPLES

Hereinafter, the present invention will be described in detail based on Examples, but the present invention is not limited to Examples. The separator used in Examples is as follows.

(Separator)

Purex #33 (thickness of 50 μm) (manufactured by Teijin DuPont Films Japan Limited)

Purex #43 (thickness of 50 μm) (manufactured by Teijin DuPont Films Japan Limited)

Purex #43 (thickness of 75 μm) (manufactured by Teijin DuPont Films Japan Limited)

Purex #71 (thickness of 75 μm) (manufactured by Teijin DuPont Films Japan Limited)

(Manufacturing Example of Acrylic Pressure-Sensitive Adhesive Composition)

70 parts by weight of 2-methoxylethyl acrylate, 29 parts by weight of 2-ethylhexyl acrylate, and 1 part by weight of 4-hydroxylbutyl acrylate, as monomer components, 0.2 part by weight of 2,2′-azobisisobutyronitrile as a polymerization initiator, and 100 parts by weight of ethyl acetate as a polymerization solvent were put into a separable flask, followed by stirring for 1 hour while introducing nitrogen gas therein. Thereafter, oxygen in the polymerization system was removed in this manner, the temperature was increased to 63° C., and the reaction was performed for 10 hours, and after that, toluene was added to obtain the acrylic polymer solution having a solid concentration of 25 wt %. The acrylic pressure-sensitive adhesive composition (solution) was prepared by adding to the acrylic polymer solution 0.7 part by weight of the aliphatic multifunctional isocyanate compound (trade name “Coronate HL” manufactured by Nippon Polyurethane Industry Co., Ltd; aliphatic isocyanate-based crosslinking agent) as a crosslinking agent, and 0.3 part by weight of polyol prepared by adding propyleneoxide to ethylenediamine (trade name “EDP-300” manufactured by ADEKA Corp.) as a crosslinking additive, based on 100 parts by weight of the acrylic polymer.

### Comparative Example 1

The acrylic pressure-sensitive adhesive composition was cast-coated on a silicon-treated surface of the Purex #33 (thickness of 50 μm) (manufactured by Teijin DuPont Films Japan Limited) so that the thickness after drying was about 50 μm, followed by heating and drying at 130° C. for 3 minutes to form a pressure-sensitive adhesive layer. Thereafter, the Purex #33 (thickness of 50 μm) was laminated to the surface of the pressure-sensitive adhesive layer, followed by aging at 23° C. for 7 days to manufacture the double-sided pressure-sensitive adhesive sheet.

### Comparative Example 2

The acrylic pressure-sensitive adhesive composition was cast-coated on a silicon-treated surface of the Purex #43 (thickness of 50 μm) (manufactured by Teijin DuPont Films Japan Limited) so that the thickness after drying was about 50 μm, followed by heating and drying at 130° C. for 3 minutes to form a pressure-sensitive adhesive layer. Thereafter, the Purex #43 (thickness of 50 μm) was laminated to the surface of the pressure-sensitive adhesive layer, followed by aging at 23° C. for 7 days to manufacture the double-sided pressure-sensitive adhesive sheet.

### Example 1

The acrylic pressure-sensitive adhesive composition was cast-coated on a silicon-treated surface of the Purex #43 (thickness of 75 μm) (manufactured by Teijin DuPont Films Japan Limited) so that the thickness after drying was about 50 μm, followed by heating and drying at 130° C. for 3 minutes to form a pressure-sensitive adhesive layer. Thereafter, the Purex #43 (thickness of 75 μm) was laminated to the surface of the pressure-sensitive adhesive layer, followed by aging at 23° C. for 7 days to manufacture the double-sided pressure-sensitive adhesive sheet.

### Example 2

The acrylic pressure-sensitive adhesive composition was cast-coated on a silicon-treated surface of the Purex #71 (thickness of 75 μm) (manufactured by Teijin DuPont Films Japan Limited) so that the thickness after drying was about 50 μm, followed by heating and drying at 130° C. for 3 minutes to form a pressure-sensitive adhesive layer. Thereafter, the Purex #71 (thickness of 75 μm) was laminated to the surface of the pressure-sensitive adhesive layer, followed by aging at 23° C. for 7 days to manufacture the double-sided pressure-sensitive adhesive sheet.

(Evaluation)

The following evaluation was performed with respect to the pressure-sensitive adhesive sheet (double-sided pressure-sensitive adhesive sheet) obtained in Examples and Comparative Examples. The evaluation results thereof are shown in Table 1.

(1) Evaluation of Punching Processability

After one side of the separator (separator which was laminated later) was released from the pressure-sensitive adhesive sheet obtained in Examples and Comparative Examples, followed by laminating with a PET film having a thickness of 188 μm, it was punched out at a speed of 100 short/min by a seal blade using a puncher (“D250” manufactured by Iwasaki Tekko Co., Ltd.) from the side of the PET film having a thickness of 188 μm. When the separator of the punched sample was released by hand, a sample without the adhesive defect was represented by “∘” and a sample with the adhesive defect was represented by “x”. The “adhesive defect” means that a part of the pressure-sensitive adhesive layer is stretched in a tread shape or omitted between the separator and the pressure-sensitive adhesive layer.

(2) High-Speed Release Force of Separator

After one side of the separator (separator which was laminated later) was released from the pressure-sensitive adhesive sheet obtained in Examples and Comparative Examples, followed by laminating with a PET film having a thickness of 25 μm, it was cut in a size of width 50 mm and length 150 mm to prepare a test sample. Under conditions of 23° C. and 50% RH, a release force at the time when the separator of the test sample is released in a machine direction (180° peel, and tensile speed of 30 m/min) was measured by using the tensile tester. The separator side was pulled when releasing.

TABLE 1

| | | Comparative | Comparative | | |
|---|---|---|---|---|---|
| | | Example 1 | Example 2 | Example 1 | Example 2 |
| Separator | Product name | Purex #33 | Purex #43 | Purex #43 | Purex #71 |
| | Thickness (μm) | 50 | 50 | 75 | 75 |
| | Breaking strength | 270 | 270 | 238 | 238 |
| | MD (MPa) | | | | |
| | Breaking strength | 270 | 270 | 238 | 238 |
| | TD (MPa) | | | | |
| | Young's modulus | 4.0 | 4.0 | 4.3 | 4.3 |
| | MD (GPa) | | | | |
| | Young's modulus | 4.0 | 4.0 | 4.3 | 4.3 |
| | TD (GPa) | | | | |
| Pressure- | Storage elastic modulus | 1.5 × 10⁶ | 1.5 × 10⁶ | 1.5 × 10⁶ | 1.5 × 10⁶ |
| sensitive | (−30° C.) (Pa) | | | | |
| adhesive layer | Thickness (μm) | 50 | 50 | 50 | 50 |
| (pressure- | Total light transmittance | 92.3 | 92.3 | 92.3 | 92.3 |
| sensitive | (%) | | | | |
| adhesive body) | Haze (%) | 0.3 | 0.3 | 0.3 | 0.3 |
| Pressure- | High-speed release force | 0.6 | 1.1 | 1.1 | 1.4 |
| sensitive | (tensile speed: 30 m/min) | | | | |
| adhesive sheet | (N/50 mm) | | | | |
| | Punching processability | x | x | ∘ | ∘ |
| | (NG number of release) | | | | |

From the evaluation results shown in Table 1, the double-sided pressure-sensitive adhesive sheet of the present invention (Example) had excellent punching processability. On the other hand, when the thickness of the separator was too thin or the high-speed release force was too small, the punching processability was deteriorated.

While the invention has been described in detail and with reference to specific embodiments thereof, it will be apparent to one skilled in the art that various changes and modifications can be made therein without departing from the spirit and scope thereof.

This application is based on Japanese Patent Application No, 2010-205508 filed on Sep. 14, 2010, and the entire subject matter of which is incorporated herein by reference.

The invention provides the following optical pressure-sensitive adhesive sheet.

(1) An optical pressure-sensitive adhesive sheet, comprising: a pressure-sensitive adhesive body; and a separator on at least one side of the pressure-sensitive adhesive body,

wherein the separator has a Young's modulus of 2 GPa or more in a machine direction and a transverse direction, a breaking strength of 400 MPa or less in a machine direction and a transverse direction, and a thickness of 70 μm or more and 250 μm or less, and

a release force of the separator to the pressure-sensitive adhesive body in a 180° peel test at a tensile speed of 30 m/min is 0.8 N/50 mm or more.

(2) The optical pressure-sensitive adhesive sheet according to (1), wherein the pressure-sensitive adhesive body comprises an acrylic pressure-sensitive adhesive layer having a storage elastic modulus of 1.0×10⁴ to 1.0×10¹⁴ Pa at a temperature of −30° C.

(3) The optical pressure-sensitive adhesive sheet according to (1) or (2), wherein the separator comprises a separator substrate and a release layer formed on at least one surface of the separator substrate.

(4) The optical pressure-sensitive adhesive sheet according to (3), wherein the release layer is formed of a release treating agent.

(5) The optical pressure-sensitive adhesive sheet according to any one of (1) to (4), wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

What is claimed is:

1. An optical pressure-sensitive adhesive sheet, comprising: a pressure-sensitive adhesive body; and a separator on at least one side of the pressure-sensitive adhesive body,
wherein the separator has a Young's modulus of 2 GPa or more in a machine direction and a transverse direction, a breaking strength of 400 MPa or less in a machine direction and a transverse direction, and a thickness of 70 μm or more and 250 μm or less, and
a release force of the separator to the pressure-sensitive adhesive body in a 180° peel test at a tensile speed of 30 m/min is 0.8 N/50 mm or more.

2. The optical pressure-sensitive adhesive sheet according to claim 1, wherein the pressure-sensitive adhesive body comprises an acrylic pressure-sensitive adhesive layer having a storage elastic modulus of 1.0×10⁴ to 1.0×10¹⁴ Pa at −30° C.

3. The optical pressure-sensitive adhesive sheet according to claim 1, wherein the separator comprises a separator substrate and a release layer formed on at least one surface of the separator substrate.

4. The optical pressure-sensitive adhesive sheet according to claim 2, wherein the separator comprises a separator substrate and a release layer formed on at least one surface of the separator substrate.

5. The optical pressure-sensitive adhesive sheet according to claim 3, wherein the release layer is formed of a release treating agent.

6. The optical pressure-sensitive adhesive sheet according to claim 4, wherein the release layer is formed of a release treating agent.

7. The optical pressure-sensitive adhesive sheet according to claim 1, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

8. The optical pressure-sensitive adhesive sheet according to claim 2, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

9. The optical pressure-sensitive adhesive sheet according to claim 3, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

10. The optical pressure-sensitive adhesive sheet according to claim 4, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

11. The optical pressure-sensitive adhesive sheet according to claim 5, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.

12. The optical pressure-sensitive adhesive sheet according to claim 6, wherein a thickness of the pressure-sensitive adhesive body is 6 to 250 μm, a total light transmittance of the pressure-sensitive adhesive body in a visible wavelength region is 80% or more, and a haze of the pressure-sensitive adhesive body is 3% or less.
